(19) United States
(12) Patent Application Publication
(10) Pub. No.: US 2008/0136060 A1
(43) Pub. Date: Jun. 12, 2008

(54) System and method for forming and curing a composite structure

(75) Inventors: Peter Shpik, Auburn, AL (US); Kenneth Shannon Hogg, Tallassee, AL (US)

Correspondence Address: QUARLES & BRADY LLP, 411 E. WISCONSIN AVENUE, SUITE 2040, MILWAUKEE, WI, 53202-4497, US

(73) Assignee: GKN Westland Aerospace, Inc.

(21) Appl. No.: 11/636,246

(22) Filed: Dec. 8, 2006

(51) Int. Cl. B29C 39/14

(52) U.S. Cl. 264/319; 425/404

(57) ABSTRACT

Embodiments of the present invention provide a system for forming a composite perform by passing resin through the composite preform. The system includes a resin flow chamber and a first chamber, which may be a vacuum or pressure chamber. The resin flow chamber includes first and second ends integrally formed with first and second sides. The first end includes a first outlet tube. The composite preform is positioned within the resin flow chamber so that resin may pass through the fiber preform. The first chamber is positioned on the first side of the resin flow chamber and includes a second outlet tube. The resin flow chamber and the first vacuum chamber are separated by a first gas permeable film that allows gases to pass therethrough, but prevents resin from passing therethrough.

### BACKGROUND OF THE INVENTION

Embodiments of the present invention generally relate to a system and method for forming and curing a composite preform, and more particularly, to a system and method of removing entrapped air within a fiber/prepreg preform during Resin Infusion Process such as a Vacuum-Assisted Resin Transfer Molding (VARTM) process, Pressure Assisted Resin Transfer Molding Process (PARTM), Bulk Infusion Process, Controlled Atmospheric Resin Transfer Molding Injection or other such resin transfer or prepreg cure processes.

In the composite industry, cylindrical fiber performs, for example, may be made of consolidated dry fiber fabric are used in numerous applications requiring a sturdy, hollow, generally cylindrical structure, such as a plane fuselage, a nacelle, the tail cone of a helicopter, or a containment case. The fiber preforms are made by tightly wrapping a sheet of dry fiber fabric around a generally cylindrical mandrel in a series of layers—not unlike a long sheet of paper towels being wrapped around a tube—until the wrapped fabric forms a generally cylindrical structure having the desired thickness, dimensions and outer diameter for the intended application of the fiber preform. A core material may be sandwiched between fabric plies to increase stiffness and reduce cost. Resin is then added into the bundle of fabric and the fabric is treated in a curing vessel such an oven, microwave, autoclave, or other such heating systems to consolidate and strengthen the fabric into a composite preform. The fabric may be made of any number of materials such as carbon, glass, or any other synthetic or natural fiber, for example.

Vacuum-Assisted Resin Transfer Molding (VARTM) is one method of applying resin to form the fiber preform. During the VARTM process, the fiber preform is positioned on a one-sided tool. Typically, a flow media, such as a thermoplastic or metal mesh plate or shell is positioned over the fiber preform. The flow media allows the resin to easily pass over and through the fiber preform.

The fiber preform is positioned within a chamber of the tool. The resin is pulled or pushed through the chamber through the use of a vacuum or pressure. For example, an air pump may draw air through the vacuum chamber, thereby forming the vacuum, and pulling the resin through the chamber, and, therefore, through the fiber preform itself. In short, the vacuum and/or pressure assists the resin through the fiber/fabric preform in the chamber generating a pressure differential.

Often, air is trapped or encapsulated within the fiber/fabric preform as the resin flows through the fiber preform. That is, some times the resin flows through the fabric preform so fast that it entraps air within the preform and does not allow complete infiltration. If the preform is large, the air may be trapped deep within the preform. In order to remove the entrapped air, additional resin may be passed into the chamber in order to flush out the air bubbles. For example, if a Resin Infusion process is supposed to use a certain amount of resin, additional resin over the normal amount may be used to flush out any air entrained, or trapped within the preform.

The speed of a typical Resin Infusion process is limited due to the fact that fast flowing resin may produce air bubbles within the preform. Additionally, at least some Resin Infusion processes may waste extra resin that is used to flush out any air bubbles. If the air bubbles are not flushed out, however, the resulting preform may have pores or other such imperfections resulting from the trapped air bubbles, thereby compromising the integrity of the preform.

Thus, a need exists for an efficient system and method for forming a fiber preform through a Resin Infusion process. A need exists for a system and method of saturating the space between fibers in an impregnable fiber preform with minimal or no internal pores and having target compaction values.

### SUMMARY OF THE INVENTION

Certain embodiments of the present invention provide a system for forming a composite perform, such as through a saturation process, by passing resin through the preform. The system includes a resin flow chamber and at least one additional chamber, such as a first chamber.

The resin flow chamber includes first and second ends integrally formed with first and second sides. An outlet tube extends from the first end. Gases within the resin flow chamber may be suctioned/compressed out of the resin flow chamber, by vacuum pressure or a pressure differential, through the first outlet tube. The preform is positioned within the resin flow chamber so that resin passes through the preform. Resin that passes through the preform may then be suctioned/compressed into the first outlet tube.

The first chamber is positioned on the first side of the resin flow chamber. A second outlet tube extends from the first chamber. The resin flow chamber and the first chamber are separated by a first gas permeable film that allows gases to pass therethrough, but prevents resin from passing therethrough. Gases within the resin flow chamber may also be suctioned/compressed into the first vacuum chamber through the first gas permeable film. The first vacuum chamber may be secured to a mold tool that is configured to be heated or cured within a heated vessel system, such as an oven.

The system may also include a second chamber positioned on the second side of the resin flow chamber. A third outlet tube extends from the second chamber. The resin flow chamber and the second chamber are separated by a second gas permeable film, wherein gases within the resin flow chamber is suctioned/compressed from the resin flow chamber through the second gas permeable film and into the second chamber.

Each of the first and second chambers may include a breather member disposed therein. The breather member is configured to draw gas away from the resin flow chamber.

The system may also include at least one compacting member, such as shrink wrap, configured to be positioned around the composite preform. The compacting member is configured to shrink around the preform when heated, such as when in a heated vessel, such as an oven, where additional pressure may be exerted on the preform.

Certain embodiments of the present invention also provide a method of forming a composite perform by passing resin through the preform. The method may include disposing a fiber preform within a resin flow chamber, securing a first chamber to one side of the resin flow chamber such that the resin flow chamber and the first chamber are separated by a first gas permeable film, drawing resin (such as through suctioning, pulling or pushing) through the preform into an outlet tube of the resin flow chamber, drawing air bubbles within the fiber preform through the outlet tube, and drawing additional air bubbles within the preform through the first gas permeable membrane into the first chamber.

The method may also include securing a second chamber to another side of the resin flow chamber such that the resin flow chamber and the second chamber are separated by a second gas permeable film, and drawing remaining air bubbles within the preform through the second gas permeable membrane into the second chamber.

The method may also include the step of exerting external pressure to an outer surface of at least one of the first and second chambers to assist in saturating, consolidating, and curing the composite preform.

### BRIEF DESCRIPTION OF SEVERAL VIEWS OF THE DRAWINGS

FIG. 1 illustrates a simplified cross-sectional view of a Resin Infusion system according to an embodiment of the present invention.

FIG. 2 illustrates a cross-sectional view of a Resin Infusion system according to an embodiment of the present invention.

FIG. 3 illustrates an isometric view of a heated vessel curing system, such as an oven, pressure box, or autoclave, used in a Resin Infusion process according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

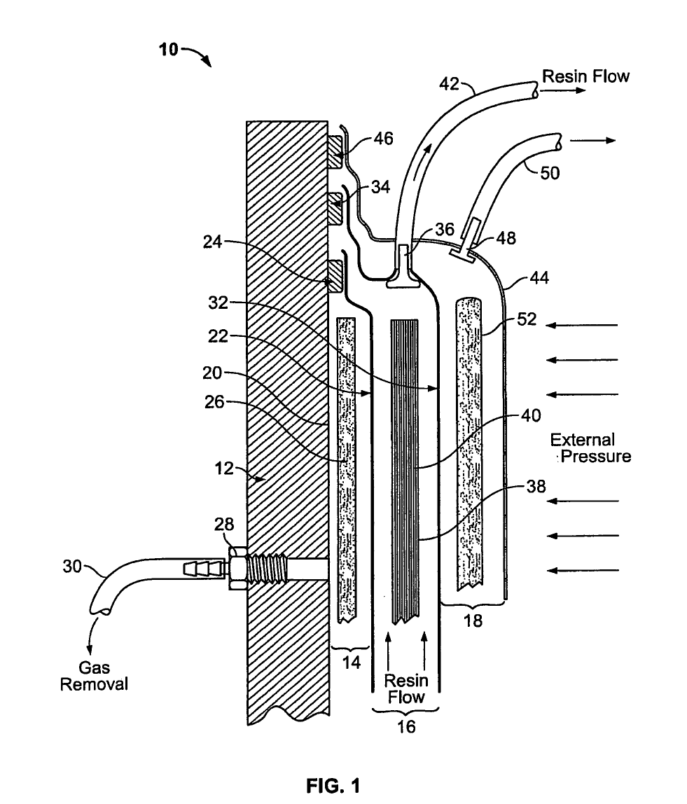

FIG. 1 illustrates a simplified cross-sectional view of a Resin Infusion system 10 according to an embodiment of the present invention. The Resin Infusion system 10 may be a VARTM system, PARTM system, Bulk Infusion system, controlled atmospheric resin transfer molding injection system, or the like. The system 10 includes a mold tool 12, a tool-side chamber 14 secured to the mold tool 12, a resin flow chamber 16 positioned over the tool-side chamber 14, and an external chamber 18 positioned over the resin flow chamber 16. Each of the tool-side, resin flow, and external chambers 14, 16, and 18, respectively, may be a vacuum or pressure chamber. For example, a vacuum pump may be operatively connected to chamber to provide vacuum or suctioning pressure within each chamber. As shown in FIG. 1, the resin flow chamber 16 is sandwiched between the tool-side chamber 14 and the external chamber 18. Optionally, the system 10 may include the resin flow chamber 16 and either the tool-side chamber 14 or the external chamber 18. For example, the resin flow chamber 16 may directly abut the mold tool 12. That is, instead of three separate chambers, the system 10 may include two chambers.

The tool-side chamber 14 is defined by an internal surface 20 of the mold tool 12 and a gas permeable film 22. The gas permeable film 22 is secured to the internal surface 20 by a bag sealant 24, such as glue, tape, or the like. The bag sealant 24 is impermeable with respect to the resin. That is, resin cannot pass through the bag sealant. The gas permeable film 22 may be a plastic membrane or other such membrane that allows gases, such as air, ammonia, water vapor, or other gaseous by-products of a Resin Infusion process, to pass therethrough, but prevents the passage of resin. In general, the gas permeable film 22 includes microscopic pores or openings that allow gas molecules to pass, but are too small to allow liquid or solids to pass. The gas permeable film 22 may be formed, for example, of fluoropolymer and thermoplastic films, such as Ethyl Triflourethylene (ETFE), coated fabrics, or other such materials.

A breather membrane, material, or layer 26 is disposed within the tool-side chamber 14. The breather material 26 may be formed of a fabric or material that allows air to pass therethrough. The breather material 26 may be formed of synthetic or natural materials, such as nylon, polyester, cotton, glass carbon, or the like, and possibly coated with release agents. In short, the breather material 26 may be made from various materials that allow easy air flow passage.

A hose fitting 28 extends through the mold tool 12 and forms a passage from the interior of the tool-side chamber 14 and an external environment. The hose fitting 28 is also connected to a hose 30, which may in turn be in fluid communication with a vacuum source (not shown), such as a vacuum pump, or open to the atmosphere.

In operation, the breather material 26 acts to transport air and other gases from the resin flow chamber 16 through the gas permeable film 22. Resin molecules within the resin flow chamber 16 are too large to pass through the film 22. Thus, resin does not pass into the tool-side chamber 14. The gases within the tool-side chamber 14 then pass through the breather material 26 and out of the system 10 through the hose 30.

The resin flow chamber 16 is defined by the gas permeable film 22 of the tool-side chamber 14 and a gas permeable film 32. The gas permeable film 32 is similar to the gas permeable film 22. The gas permeable film 32 may be secured to the internal surface 20 of the mold tool 12 through a bag sealant 34, similar to the bag sealant 24. Optionally, the gas permeable film 32 may be secured to the gas permeable film 22 through a bag sealant.

An outlet tube 36 is sealingly secured to an upper end of the film 32 and is in fluid communication with the interior of the resin flow chamber 16. A composite preform 38, such as a fiber or fabric preform, is positioned within the resin flow chamber 16. A resin permeable release material may also be positioned over or within the preform 38. The release material allows resin to flow freely across the preform 38. The release material may fully or partially encapsulate the preform 38. The release material may be synthetic or naturally occurring fiber of fabric (such as nylon, polyester, or cotton), coated with a release agent. A flow medium 40 may be positioned over the fiber preform 38, including the release agent, in order to allow resin to easily pass through the fiber preform 38. The resin permeable release material allows the flow medium 40 to be easily removed after a curing process. The flow medium 40 is formed of a material that has less flow resistance than the preform 38. The flow medium 40 may be a synthetic or naturally occurring material, such as nylon, polyester, metal, or cotton, and constructed to allow resin to easily flow around the preform 38. The flow medium 40 allows the resin to pass through the preform 38 easier than if no flow medium 40 was used.

A resin source (not shown) may be positioned proximate the resin flow chamber 16. That is, resin is passed into the resin flow chamber 16 and exits through the outlet tube 36. The resin moves through the preform 38 by way of vacuum pressure or a pressure differential. A vacuum source (not shown) may be operatively connected to a hose 42, which is in turn operatively connected to the outlet tube 36. The vacuum source provides suctioning pressure, or a pressure differential within the resin flow chamber 14 that draws the resin through the fiber preform and through the hose 42.

The resin within the resin flow chamber 16 is prevented from passing into the tool side chamber 14 by the gas permeable film 22. Similarly, the resin is prevented from passing into the external vacuum chamber by the gas permeable film 32.

Gas and resin within the resin flow chamber 16 are drawn out of the resin flow chamber 16 from above through the hose 42. Gases within the resin flow chamber 16 are drawn out from one side by the tool side chamber 14, and from another side by the external chamber 18. The multiple vacuum chambers 14, 16, and 18 provide a larger area for air and other gases to be removed, as compared to a single chamber. For example, air trapped within the preform 38 is drawn upwardly by the vacuum or pressure differential created by the vacuum source (not shown) connected to the hose 42. Similarly, the vacuum/pressure within the tool side chamber 14 and the breather material 26 draw air trapped within the preform 38 through the gas permeable film 22, into the breather material 26, and out through the vacuum hose 30. The external chamber 18 draws air and other gases from the fiber preform in a similar fashion.

The external chamber 18 is defined by the gas permeable film 32 and an outer film 44 The outer film 44 may be secured to the interior surface 20 of the mold tool 12 through a bag sealant 46. The outer film 44 may be impermeable to gas and liquid, thereby ensuring that any gases drawn from the preform 38 during the Resin Infusion process do not escape to the external environment. For example, the outer film 44 may be a solid piece of plastic including multiple layers of material that are impervious to air, moisture, and anything else. Alternatively, the outer film 44 may be secured to the gas permeable film 32 through a bag sealant.

An outlet tube 48 is sealingly secured to the film 44 and is in fluid communication with the interior of the external chamber 18. The outlet tube 48 is connected to a hose 50, which is in turn may be connected to a vacuum source (not shown) or to the atmosphere to create a pressure differential that is operable to draw allow gases to pass out of the chamber 18.

A breather material 52 is disposed within the external chamber 18. The breather material 52 is similar to the breather material 26, and acts to draw air away from the fiber preform 38 in a similar fashion.

Pressure exerted into the outside of the film 44 may produce a pressure differential between the chambers 14, 16, and 18. A compacting material, such as shrink wrap, may be configured to compress the external surface of the film 44 in order to increase the pressure differential. Pressure, such as increased air pressure, may be exerted into the film 44 before, during, and/or after resin injection, or during a curing process.

As shown in FIG. 1, air trapped within the preform 38 may be drawn out from three different sides. As mentioned above, air trapped within the preform 38 may be drawn out from above, or from the sides. That is, trapped air may be drawn out through the hose 42, through the hose 30 positioned through the mold tool 12, and through the hose 50. Thus, if an air bubble is trapped within a lower portion of the preform 38, the air bubble may be drawn out through a lateral portion of the preform 38, instead of being drawn from above (and thereby traveling through the entire length of the preform 38). Thus, air bubbles within the preform 38 may be purged quickly and efficiently from three different directions, without flushing the preform with additional resin.

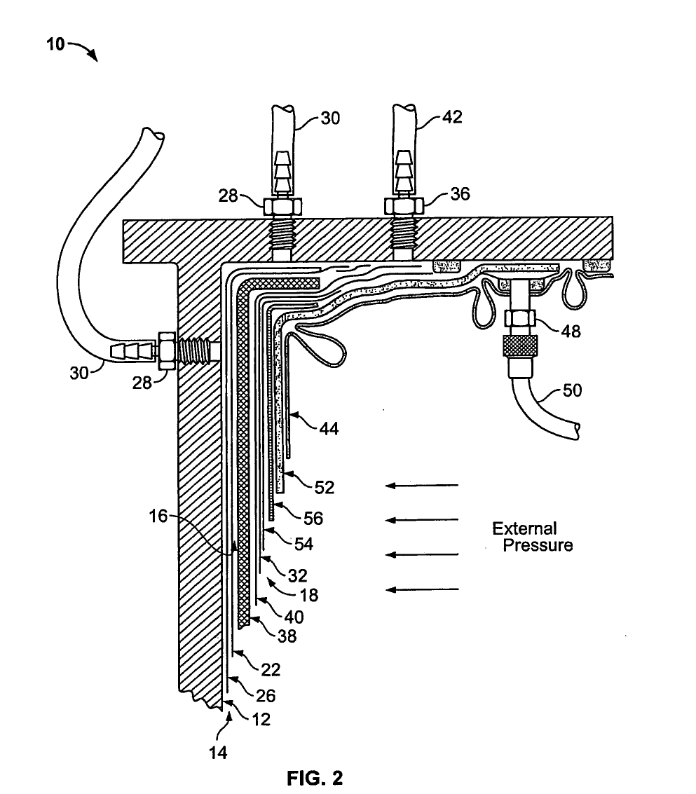

FIG. 2 illustrates a cross-sectional view of the Resin Infusion system 10. FIG. 2 is a more detailed view of the Resin Infusion system 10 shown in FIG. 1. As shown in FIG. 2, more than one hose 30 may be in fluid communication with the tool side chamber 14 through the mold tool 12. Additionally, the outlet tubes 36 and 48 may be standard hose fittings, similar to the hose fitting 28 described in FIG. 1. Also, as shown in FIG. 2, the outlet tube 36 of the resin flow chamber 16 may pass through a portion of the mold tool 12. The outlet tube 48 extends from the external chamber 18 to an external ambient environment or vacuum system.

A breather material 54, in addition to the breather material 52, may be positioned within the external chamber 18. The breather material 54 may provide increased gas drawing ability so that air bubbles may be drawn from the preform 38 quicker.

Additionally, a flexible compacting layer 56 may be positioned within or between the breather materials 52, 54, and the external chamber 18. The compacting layer 56 may be a synthetic or natural occurring shrinkable material, such as a polyester shrink wrap, or another such material configured to conform to the shape of the prefrom 38 with increased temperature.

Referring to FIGS. 1 and 2, during a Resin Infusion process, the system 10 may be positioned within a heated vessel curing system, such as an oven, pressure box, or autoclave. Resin at room temperature is viscous, and does not flow easily. As such, the resin is heated to reduce its viscosity so that it can flow freely. When the system 10 is heated, the compacting layer 56 shrinks around the preform 38 and flow medium 40, thereby ensuring that the preform 38 maintains its shape. Additionally, external pressure, such as air pressure, exerted into the exterior film 44 may produce a pressure differential between the chambers 14, 16, and 18, as discussed above.

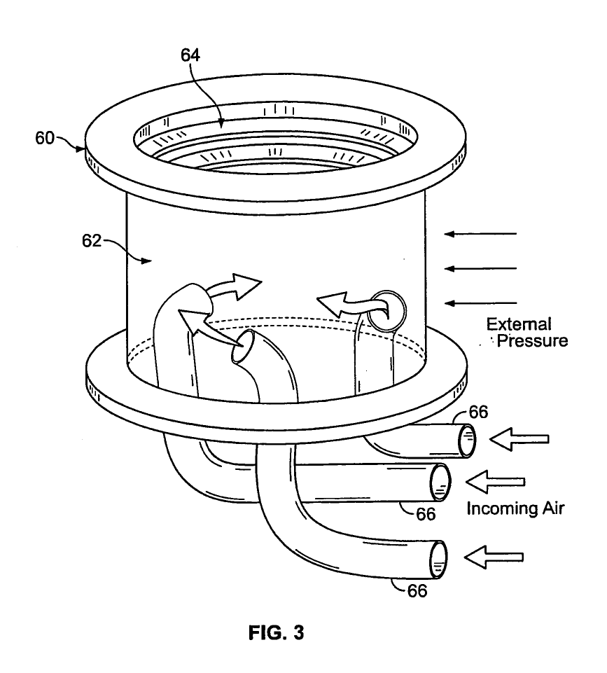

FIG. 3 illustrates an isometric view of a heated curing vessel, such as an oven 60 used in a Resin Infusion process according to an embodiment of the present invention. It is to be understood that while the heated curing vessel is described as an oven, it may be a pressure box, an autoclave, or the like. The oven 60 includes a main body 62 defining an internal chamber 64. Air tubes 66 extend into the oven 60 and allow air to pass into and circulate within the internal chamber 64. Air flow is directed in an ascending spiral along the internal surface of the main body 62. The system 10 shown in FIGS. 1 and 2 is positioned within the internal chamber, and heated air that passes into the internal chamber 64 is directed at the mold tool 12.

Referring to FIGS. 1-3, the temperature of the heated curing vessel, such as the oven 60, may be ramped up to a particular temperature. Air moving into the oven 60 may be higher than the desired temperature differential between the tool and air. Air flow moving into the oven 60 is diverted to the inner surface of the mold tool 12. Thus, the mold tool 12 heats up faster than the external chamber 18. As such, a thermal gradient exists between the mold tool 12 and the chambers 14, 16, and 18. Thus, the system 10 heats up through a process of heat transfer between the mold tool 12 and the chambers 14, 16, and 18. That is, basic thermodynamic laws dictate that heat passes to the cooler areas (warm air migrates to areas that are less warm). Thus, hot air that is diverted into the mold tool 12 heats the mold tool 12 faster through the forced air convection process and conduction of the external pressure. The heat within the mold tool 12 passes to the other components of the system 10, including the resin chamber 14. As such, the resin within the resin chamber 14 may be heated to a desired flow viscosity quicker than if heated air were not directed into the mold tool 12.

When the resin is heated to a particular temperature at a particular rate, its viscosity may be minimal. As such, the pressure differential may draw the resin within the resin flow chamber 16 so that it passes through the preform 38. While the system 10 is shown having one vacuum port outlet tube 36, more ports may be used to draw the resin through faster by the volume of displaced air.

If resin is pulled or pushed through the preform 38 too fast, however, the pulling or pushing force of the resin through the preform 38 may distort the size and shape of the preform 38. As mentioned above, however, the compacting layer 56, such as shrink tape, shrinks (when heated) to conform to the shape of the fiber preform. Thus, the shrinking nature of the compacting layer 56 and the external pressure exerted into the film 44 stabilizes the preform. As such, the system 10 is capable of accommodating higher resin velocities through the fiber preform 38 due to the fact that the compacting layer 56 and the exerted external pressure protect the preform 38 from being distorted as the resin is forced through the preform 38.

During the Resin Infusion process, air bubbles trapped within the preform 38 are drawn out from three locations of the preform 38 through the hoses 30, 42, and 50. The viscosity of the resin decreases as the temperature increases. The lower the viscosity of the resin, the faster it is able to penetrate through the preform 38. The compacting layer 56 conforms to the shape of the preform 38 with increased temperatures and external pressure to maintain the size and shape of the preform 38 as resin flows therethrough.

After all air bubbles are drawn out of the preform 38, the temperature of the oven 60 is increased in order to accelerate the curing process of the preform 38. Again, as the temperature increases, the compacting layer 56 continues to shrink, thereby exerting an increased compacting force into the preform 38. As the compacting layer 56 continues to shrink around the preform 38, the shape of the preform consolidates, and any remaining air bubbles are forced out of the preform 38. Further, the force exerted into the preform 38 by the compacting layer 56 exerts a compressive force into any remaining air bubbles, thereby squeezing the bubbles smaller until they pass through the preform 38. Additional exterior pressure may also be used to assist during saturation, consolidation, and/or curing processes.

After the preform 38 is properly cured, the system 10 is removed from the curing vessel, such as the oven 60, and allowed to cool. The preform 38 is then removed from the system 10.

Thus, embodiments of the present invention provide an efficient system and method for forming a fiber preform through a Resin Infusion process. Further, embodiments of the present invention provide a system and method of forming an impregnable fiber preform with minimal or no internal or external pores.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for forming a composite perform by passing resin through the composite preform, comprising:
a resin flow chamber having first and second ends integrally formed with first and second sides, said first end having a first outlet tube, wherein the fiber preform is positioned within said resin flow chamber so that resin may pass through the fiber preform; and
a first chamber positioned on said first side of said resin flow chamber, said first vacuum chamber having a second outlet tube, said resin flow chamber and said first chamber being separated by a first gas permeable film that allows gas to pass therethrough, but prevents resin from passing therethrough.

2. The system of claim 1, wherein gas within said resin flow chamber passes out of said resin flow chamber through said first outlet tube.

3. The system of claim 1, wherein gas within said resin flow chamber passes out of said resin flow chamber through said first gas permeable film and into said second outlet tube.

4. The system of claim 1, further comprising a second chamber positioned on said second side of said resin flow chamber, said second chamber having a third outlet tube, said resin flow chamber and said second chamber being separated by a second gas permeable film, wherein gas within said resin flow chamber passes out of said resin flow chamber through said second gas permeable film and into said third outlet tube.

5. The system of claim 4, wherein said resin flow chamber is sandwiched between said first and second chambers.

6. The system of claim 4, wherein each of said first and second chambers comprises a breather member configured to draw gas away from said resin flow chamber.

7. The system of claim 1, further comprising at least one compacting member configured to be positioned around the composite preform, wherein said at least compacting member is configured to shrink around the composite preform when heated.

8. The system of claim 7, wherein said at least one compacting member comprises shrink wrap.

9. The system of claim 1, wherein said first chamber is secured to a mold tool that is configured to be heated, and wherein external pressure is exerted into at least a portion of said tool.

10. A method of forming a composite perform by passing resin through the composite preform, comprising:
disposing a fiber preform within a resin flow chamber;
securing a first chamber to one side of the resin flow chamber such that the resin flow chamber and the first chamber are separated by a first gas permeable film;
flowing resin through the composite preform into an outlet tube of the resin flow chamber;
removing air bubbles within the composite preform through the outlet tube; and
removing additional air bubbles within the composite preform through the first gas permeable membrane into the first vacuum chamber.

11. The method of claim 10, passing the additional air bubbles within the first chamber into a second outlet tube connected to the first chamber.

12. The method of claim 10, further comprising:
securing a second chamber to another side of the resin flow chamber such that the resin flow chamber and the second chamber are separated by a second gas permeable film;
removing remaining air bubbles within the composite preform through the second gas permeable membrane into the second chamber.

13. The method of claim 12, further comprising:
disposing a first breather member within the first chamber; and
disposing a second breather member within the second chamber.

14. The method of claim 10, further comprising securing at least one compacting member the composite preform, wherein the at least one compacting member is configured to shrink around the fiber preform when heated.

15. The method of claim 10, further comprising disposing a flow medium over the composite preform.

16. The method of claim 12, further comprising exerting external pressure to an outer surface of at least one of the first and second chambers to assist in saturating, consolidating, and curing the composite preform.

17. A system for forming a composite perform by passing resin through the composite preform, comprising:
a resin flow chamber having first and second ends integrally formed with first and second sides, said first end having a first outlet tube, wherein the composite preform is positioned within said resin flow chamber so that resin may pass through the composite preform;
a tool configured to be heated;
a tool-side chamber secured to said tool and positioned on said first side of said resin flow chamber, said tool-side chamber having a second outlet tube, said resin flow chamber and said tool-side chamber being separated by a first gas permeable film that allows gas to pass therethrough, but prevents resin from passing therethrough; and
an external chamber positioned on said second side of said resin flow chamber, said external vacuum chamber having a third outlet tube, said resin flow chamber and said external chamber being separated by a second gas permeable film,
said tool-side chamber and said external chamber acting to draw gas within said resin flow chamber away from said resin flow chamber.

18. The system of claim 17, wherein gas within said resin flow chamber passes out of said resin flow chamber through at least one of said first outlet tube, said first gas permeable film, and said second gas permeable film.

19. The system of claim 17, wherein said resin flow chamber is sandwiched between said tool-side and external chambers.

20. The system of claim 17, wherein each of said tool-side and external chambers comprises a breather member configured to draw gas away from said resin flow chamber.

21. The system of claim 17, further comprising at least one compacting member configured to be positioned around the composite preform, wherein said at least compacting member is configured to shrink around the composite preform when heated.
